(19) United States
(12) Patent Application Publication
(10) Pub. No.: US 2021/0294621 A1
(43) Pub. Date: Sep. 23, 2021

(54) ACCESSIBILITY OF SOFTWARE APPLICATIONS ON MOBILE DEVICES

(71) Applicant: HCL TECHNOLOGIES LIMITED, New Delhi (IN)

(72) Inventors: Navin SAINI, Noida (IN); Monika PRASHAR, Noida (IN); Yogesh GUPTA, Noida (IN); Akhilesh Chandra SINGH, Noida (IN); Rajesh Babu SURAPARAJU, Chennai (IN)

(73) Assignee: HCL TECHNOLOGIES LIMITED, New Delhi (IN)

(21) Appl. No.: 17/201,881

(22) Filed: Mar. 15, 2021

(30) Foreign Application Priority Data
Mar. 17, 2020 (IN) 202011011521

(51) Int. Cl. G06F 9/451; G06K 9/34

(52) U.S. Cl. CPC G06F 9/453; G06K 2209/01; G06K 9/344

(57) ABSTRACT

Disclosed is a method and system for improving accessibility of software applications on mobile devices. The method comprises capturing in background, images of different user interfaces of a software application when the software application is browsed on a mobile device, using an accessibility helper tool. A pre-trained data model may be used to identify, elements and metadata of the elements present in the images. Based on the metadata, accessibility parameters of the elements may be analysed to generate a report for validation.

### CROSS-REFERENCE TO RELATED APPLICATIONS AND PRIORITY

The present application claims benefit from Indian Patent Application No. 202011011521 filed on 17 Mar. 2020 the entirety of which is hereby incorporated by reference.

### TECHNICAL FIELD

The present subject matter described herein, in general, relates to software applications, and more particularly to accessibility of software applications built for mobile devices.

### BACKGROUND

Mobile application developers develop software applications for performing required functions. Such software applications run on various platforms, operating systems, and devices. Each device can have different form factors and resolutions. Due to such variation, the content accessibility gets compromised on a few devices.

Conventional solutions include HTML editor tools that can assist a developer in creating HTML pages on accessibility guidelines, and help in building websites that are compliant to the accessibility guidelines. Therefore, currently, there are no relevant applications available for mobile devices that can assist in checking accessibility of a software application or a website available for the mobile devices.

Therefore, there remains a need of a system and a method that can assist mobile application developers to design and develop software applications that can run on various mobile devices having different form factors.

### SUMMARY

Before the present systems and methods for improving accessibility of a software application on a mobile device, are described, it is to be understood that this application is not limited to the particular systems, and methodologies described, as there can be multiple possible embodiments which are not expressly illustrated in the present disclosures. It is also to be understood that the terminology used in the description is for the purpose of describing the particular implementations or versions or embodiments only, and is not intended to limit the scope of the present application.

This summary is provided to introduce aspects related to a system and a method for improving accessibility of a software application on a mobile device. This summary is not intended to identify essential features of the claimed subject matter nor is it intended for use in determining or limiting the scope of the claimed subject matter.

In one implementation, a system for improving accessibility of a software application on a mobile device is disclosed. In one aspect, the system comprises a memory, and a processor coupled to the memory. Further, the processor may be capable of executing instructions in the memory to perform one or more steps described now. The processor may capture images of different user interfaces of a software application in background when the software application is browsed on a mobile device, using an accessibility helper tool. The processor may identify, using a pre-trained data model, elements and metadata of the elements present in the images. The elements may comprise buttons, text boxes, and labels. The metadata may include colour and size of the elements. The processor may analyze, based on the metadata, accessibility parameters of the elements to generate a report for validation. The accessibility parameters include size, colour, and readability of the elements.

During the validation, a ratio of a button size with a form factor of the mobile device may be analysed. In another case, a ratio of text size with screen size of the mobile device may be analysed, during the validation. Optical Character Recognition (OCR) may be performed for determining readability of a content present on a screen of the user device. In yet another case, colour codes of content displayed on a screen of the mobile device may be determined and compared against predefined accessibility standards, during the validation.

### BRIEF DESCRIPTION OF THE DRAWINGS

The foregoing detailed description of embodiments is better understood when read in conjunction with the appended drawings. For the purpose of illustrating of the present subject matter, an example of construction of the present subject matter is provided as figures; however, the invention is not limited to the specific method and system disclosed in the document and the figures.

The present subject matter is described in detail with reference to the accompanying figures. In the figures, the left-most digit(s) of a reference number identifies the figure in which the reference number first appears. The same numbers are used throughout the drawings to refer various features of the present subject matter.

FIG. 1 illustrates a network architecture diagram 100 of a system 102 for improving accessibility of a software application on a mobile device, in accordance with an embodiment of the present subject matter.

FIG. 2 illustrates a block level diagram of the system 102, in accordance with an embodiment of the present subject matter.

FIG. 3 illustrates a method 300 for improving accessibility of a software application on a mobile device, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods for improving accessibility of a software application on a mobile device, similar or equivalent to those described herein can be used in the practice or testing of embodiments of the present disclosure, the exemplary, systems and methods for improving accessibility of a software application on a mobile device are now described. The disclosed embodiments for improving accessibility of a software application on a mobile device are merely examples of the disclosure, which may be embodied in various forms.

Various modifications to the embodiment will be readily apparent to those skilled in the art and the generic principles herein may be applied to other embodiments for improving accessibility of a software application on a mobile device. However, one of ordinary skill in the art will readily recognize that the present disclosure for improving accessibility of a software application on a mobile device is not intended to be limited to the embodiments described, but is to be accorded the widest scope consistent with the principles and features described herein.

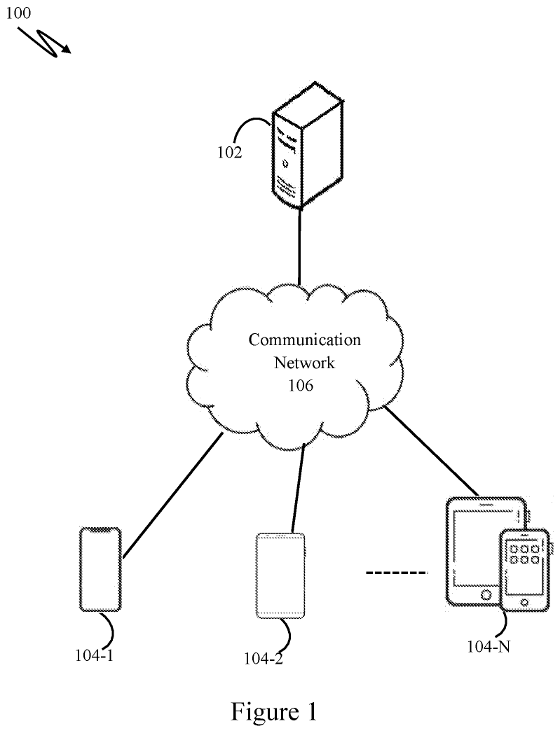

Referring now to FIG. 1, a network implementation diagram 100 of a system 102 for improving accessibility of a software application on a mobile device, in accordance with an embodiment of the present subject matter may be described. In one example, the system 102 may be connected with mobile devices 104-1 through 104-N (collectively referred as 104) through a communication network 106.

It should be understood that the system 102 and the mobile devices 104 correspond to computing devices. It may be understood that the system 102 may also be implemented in a variety of computing systems, such as a laptop computer, a desktop computer, a notebook, a workstation, a mainframe computer, a server, a network server, a cloud-based computing environment, or a smart phone and the like. It may be understood that the mobile devices 104 may correspond to a variety of a variety of portable computing devices, such as a laptop computer, a desktop computer, a notebook, a smart phone, a tablet, a phablet, and the like.

In one implementation, the communication network 106 may be a wireless network, a wired network, or a combination thereof. The communication network 106 can be implemented as one of the different types of networks, such as intranet, Local Area Network (LAN), Wireless Personal Area Network (WPAN), Wireless Local Area Network (WLAN), wide area network (WAN), the internet, and the like. The communication network 106 may either be a dedicated network or a shared network. The shared network represents an association of the different types of networks that use a variety of protocols, for example, MQ Telemetry Transport (MQTT), Extensible Messaging and Presence Protocol (XMPP), Hypertext Transfer Protocol (HTTP), Transmission Control Protocol/Internet Protocol (TCP/IP), Wireless Application Protocol (WAP), and the like, to communicate with one another. Further, the communication network 106 may include a variety of network devices, including routers, bridges, servers, computing devices, storage devices, and the like.

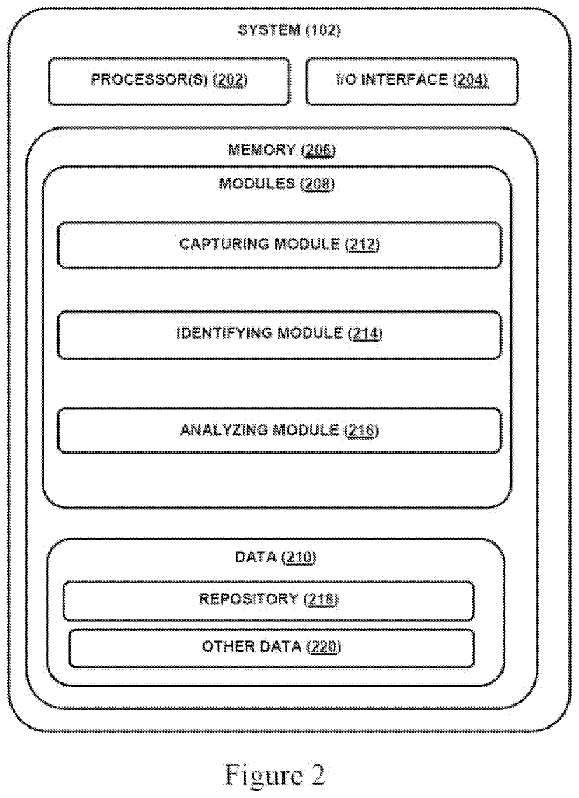

Referring now to FIG. 2, a block diagram 200 of the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 may be configured to fetch and execute computer-readable instructions stored in the memory 206.

The I/O interface 204 may include a variety of software and hardware interfaces, for example, a web interface, a graphical user interface, a command line interface, and the like. The I/O interface 204 may allow a user to interact with the system 102. Further, the I/O interface 204 may enable the system 102 to communicate with the mobile devices 104, and other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206, amongst other things, serves as a repository for storing data processed, received, and generated by one or more of modules 208. The memory 206 may include any computer-readable medium or computer program product known in the art including, for example, volatile memory, such as Static Random Access Memory (SRAM) and Dynamic Random Access Memory (DRAM), and/or non-volatile memory, such as Read Only Memory (ROM), Erasable Programmable ROM (EPROM), Electrically Erasable and Programmable ROM (EEPROM), flash memories, hard disks, optical disks, and magnetic tapes.

The memory 206 may include data generated as a result of the execution of one or more of the modules 208. In one implementation, the memory 206 may include data 210. The modules 208 include routines, programs, objects, components, data structures, etc., which perform particular tasks or implement particular abstract data types. In one implementation, the modules 208 may include a capturing module 212, an identifying module 214, and an analyzing module 216. The modules 208 described herein may be implemented as software modules that may be executed in the cloud-based computing environment of the system 102.

The data 210 may include a repository 218 for storing data processed, computed, received, and generated by one or more of the modules 208. Furthermore, the data 210 may include other data 220 for storing data generated as a result of the execution of modules than the ones mentioned above.

In one implementation, to improve accessibility of a software application on a mobile device of the mobile devices 104, at first, visual appearance of a software application installed on the mobile device may be tested by a software tester. To test the visual appearance of the software application, the software tester may utilize an accessibility helper tool. Using the accessibility helper tool, different User Interfaces (UIs) of the software application may be visited. While going through the different UIs, images of the different UIs may be captured in background. In one case, the images may be captured by the accessibility helper tool.

In one embodiment, a pre-trained data model may be executed on the images. The pre-trained data model may identify elements present in the images. The elements, for example, may comprise buttons, text boxes, and labels. Further, metadata of the elements may also be identified by the pre-trained data model. The metadata, for example, may comprise colour and size of the elements.

Based on the metadata, accessibility parameters such as size, colour, and readability of the elements may be analysed. A report may be generated based on the analysis of the accessibility parameters, for validation. During the validation, several factors related to the elements and the mobile device may be analysed. In one case, a ratio of a button size with a form factor of the mobile device may be analysed during the validation. In another case, a ratio of text size with screen size of the mobile device may be analysed during the validation. Optical Character Recognition (OCR) may be performed for determining readability of a content present on a screen of the user device. In yet another case, colour codes of content displayed on a screen of the mobile device may be determined and compared against predefined accessibility standards during the validation.

Therefore, as described above, current invention provides an accessibility helper tool that produces reports for developers of a mobile application. The report highlights areas of accessibility that can be improved upon while developing the mobile application, such as size, colour, contrast, and readability of content of the mobile application.

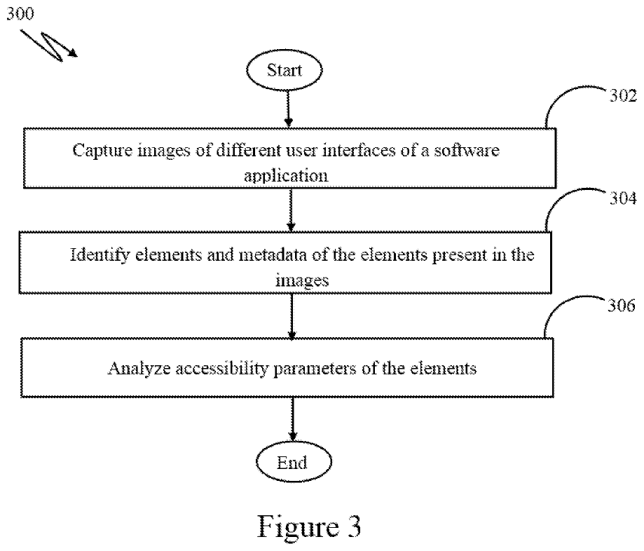

Referring now to FIG. 3, a method 300 to improve accessibility of a software application on a mobile device is described, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types.

The order in which the method 300 to improve accessibility of a software application on a mobile device is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented in the above described system 102.

At block 302, images of different user interfaces of a software application may be captured in background, when the software application is browsed on a mobile device. The images may be captured using an accessibility helper tool.

At block 304, elements and metadata of the elements present in the images may be identified using a pre-trained data model. The elements may comprise buttons, text boxes, and labels. The metadata includes colour and size of the elements.

At block 306, accessibility parameters of the elements may be analysed based on the metadata to generate a report for validation. The accessibility parameters may include size, colour, and readability of the elements. In one case, a ratio of a button size with a form factor of the mobile device may be analysed during the validation. In another case, a ratio of text size with screen size of the mobile device may be analysed during the validation. Optical Character Recognition (OCR) may be performed for determining readability of a content present on a screen of the user device. In yet another case, colour codes of content displayed on a screen of the mobile device may be determined and compared against predefined accessibility standards during the validation.

Although implementations for methods and systems for improving accessibility of a software application on a mobile device have been described in language specific to structural features and/or methods, it is to be understood that the appended claims are not necessarily limited to the specific features or methods described. Rather, the specific features and methods are disclosed as examples of implementations for improving accessibility of a software application on a mobile device.

1. A method of improving accessibility of a software application on a mobile device, the method comprising:
capturing in background, images of different user interfaces of a software application when the software application is browsed on a mobile device, using an accessibility helper tool;
identifying, using a pre-trained data model, elements and metadata of the elements present in the images; and
analyzing, based on the metadata, accessibility parameters of the elements to generate a report for validation.

2. The method as claimed in claim 1, wherein the elements comprise buttons, text boxes, and labels.

3. The method as claimed in claim 1, wherein the metadata includes colour and size.

4. The method as claimed in claim 1, wherein the accessibility parameters include size, colour, and readability of the elements.

5. The method as claimed in claim 1, wherein a ratio of a button size with a form factor of the mobile device is analysed during the validation.

6. The method as claimed in claim 1, wherein a ratio of text size with screen size of the mobile device is analysed during the validation.

7. The method as claimed in claim 1, further comprising performing Optical Character Recognition (OCR) for determining readability of a content present on a screen of the user device.

8. The method as claimed in claim 1, wherein colour codes of content displayed on a screen of the mobile device are determined and compared against predefined accessibility standards during the validation.

9. A system for improving accessibility of a software application on a mobile device, the system comprising:
a memory; and
a processor coupled to the memory, wherein the processor is capable of executing instructions to perform steps of:
capturing in background, images of different user interfaces of a software application when the software application is browsed on a mobile device, using an accessibility helper tool;
identifying, using a pre-trained data model, elements and metadata of the elements present in the images; and
analyzing, based on the metadata, accessibility parameters of the elements to generate a report for validation.

10. The system as claimed in claim 9, wherein the elements comprise buttons, text boxes, and labels.

11. The system as claimed in claim 9, wherein the metadata includes colour and size.

12. The system as claimed in claim 9, wherein the accessibility parameters include size, colour, and readability of the elements.

13. The system as claimed in claim 9, wherein a ratio of a button size with a form factor of the mobile device is analysed during the validation.

14. The system as claimed in claim 9, wherein a ratio of text size with screen size of the mobile device is analysed during the validation.

15. The system as claimed in claim 9, further comprising performing Optical Character Recognition (OCR) for determining readability of a content present on a screen of the user device.

16. The system as claimed in claim 9, wherein colour codes of content displayed on a screen of the mobile device are determined and compared against predefined accessibility standards during the validation.

17. A non-transitory computer program product having embodied thereon a computer program for improving accessibility of a software application on a mobile device, the computer program product storing instructions for:
capturing in background, images of different user interfaces of a software application when the software application is browsed on a mobile device, using an accessibility helper tool;
identifying, using a pre-trained data model, elements and metadata of the elements present in the images; and
analyzing, based on the metadata, accessibility parameters of the elements to generate a report for validation.
